(19) United States
(12) Patent Application Publication
(10) Pub. No.: US 2014/0153696 A1
(43) Pub. Date: Jun. 5, 2014

(54) GENERATION OF MULTIPLE X-RAY ENERGIES

(71) Applicants: Rolf Karl Otto Behling, Norderstedt (DE); Wolfram Maring, Hamburg (DE)

(72) Inventors: Rolf Karl Otto Behling, Norderstedt (DE); Wolfram Maring, Hamburg (DE)

(73) Assignee: KONINKLIJKE PHILIPS N.V., EINDHOVEN (NL)

(21) Appl. No.: 14/236,080

(22) PCT Filed: Jul. 24, 2012
(86) PCT No.: PCT/IB2012/053756

§ 371 Date: Jan. 30, 2014

Related U.S. Application Data
(60) Provisional application No. 61/513,715, filed on Aug. 1, 2011.

(51) Int. Cl. H01J 35/14

(52) U.S. Cl. CPC H01J 35/14
USPC 378/62; 378/138

(57) ABSTRACT

The present invention relates to the generation of multiple X-ray energies in an X-ray tube. In order to provide an X-ray tube capable of generating multiple-energy X-ray radiation with a minimized design setup and an improved switching capacity, a multiple-energy X-ray tube (10) comprises a cathode (12), an anode (14) and an electron-braking device (16). The anode comprises a target surface (18) provided for generating X-rays as a result of impinging electrons. The cathode is provided for emitting electrons (20, 144, 148, 150) towards the anode to impinge on the target surface of the anode. The electron-braking device is intermittently arrangeable in a pathway (22, 144, 148, 150) of the electrons from the cathode to the anode and configured to slow at least a part of the electrons of the electron beam such that the energy of re-emitted electrons is lower than the energy of arriving electrons.

### FIELD OF THE INVENTION

The present invention relates to the generation of multiple X-ray energies in an X-ray tube. The present invention relates in particular to a multiple-energy X-ray tube, an X-ray imaging system, a method for generating multiple-energy X-ray radiation, a computer program element and a computer readable medium.

### BACKGROUND OF THE INVENTION

Multiple-energy X-ray radiation provides enhanced object information that can be provided to a user. For example, using multiple X-ray photon energies, which are also referred to as X-ray colours, may enhance the diagnostic value of an X-ray image of a patient, for example. Multiple X-ray energies also provide enhanced information for material investigation purposes or object inspection purposes, such as luggage screening at security-relevant points, like airports. In order to generate X-ray radiation with different X-ray energies, for example, multiple X-ray tubes are used. Further, a single X-ray tube may be supplied with alternating tube voltages in order to provide different X-ray energy radiation. Documents WO2011051860 A3 and WO 2010061324 A1 describe the generation of X-ray radiation with multiple spectra (e.g. dual energy X-rays). Other methods are based on using multiple X-ray tubes with multiple tube voltages and X-ray filters. However, providing multiple X-ray tubes is expensive, occupies valuable construction space, and also means a rather complex system. Using a single X-ray tube with alternating tube voltages may have the disadvantage of slow operation, for example, due to the large capacity of the h/v circuitry (high-voltage circuitry). Other tube types may have a limited power rating, only.

### SUMMARY OF THE INVENTION

Thus, there is a need to provide an X-ray tube capable of generating multiple-energy X-ray radiation with a reduced design setup and an improved switching capacity.

The object of the present invention is solved by the subject-matter of the independent claims, wherein further embodiments are incorporated in the dependent claims.

It should be noted that the following described aspects of the invention apply also for the multiple-energy X-ray tube, the X-ray imaging system, the method for generating multiple-energy X-ray radiation, as well as for the computer program element and the computer readable medium.

According to a first aspect of the present invention, a multiple-energy X-ray tube is provided, that comprises a cathode, an anode, and an electron-braking device. The anode comprises a target surface provided for generating X-rays as a result of impinging electrons. The cathode is provided for emitting electrons towards the anode to impinge on the target surface of the anode. The electron-braking device is intermittently arrangeable in a pathway of the electrons from the cathode to the anode and configured to slow at least a part of the electrons of the electron beam such that the energy of re-emitted electrons is lower than the energy of arriving electrons.

The term “intermittently” refers to an arrangement in the pathway in one position and an arrangement outside the pathway in another position, which positions can be provided in an alternating and repetitive manner.

According to an exemplary embodiment of the invention, the electron-braking device comprises an electron-braking layer arrangeable in the electron pathway towards the anode such that at least a part of the electrons pass through the layer. The electron-braking layer is configured such that at least a part of the incoming electrons loose at least a part of their energy to electromagnetic radiation, phonons and/or other electrons. On the rear side of the electron-braking layer, electrons are released as outgoing electrons towards the anode with a lower energy than the incoming electrons.

According to another exemplary embodiment of the invention, the electron-braking device comprises an electron-braking body with an auxiliary target surface, arrangeable in the electron pathway towards the anode such that at least a part of the electrons impinge onto the auxiliary target surface. From this surface, electrons are released as outgoing electrons, e.g. back-scattered electrons, towards the anode with a lower energy than the incoming electrons.

According to another exemplary embodiment of the invention, an electro-magnetic electron-braking device is provided, wherein electrons which are passing through it, loose energy by generating electromagnetic radiation.

For example, the electro-magnetic electron-braking device may be provided as an Undulator or Synchrotron device.

According to an exemplary embodiment of the invention, the cathode is connected to a first electrical potential, the anode is connected to a second electrical potential, and the electron-braking device is connected to a third electrical potential with a voltage arranged between the first and the second electrical potential. A first effective tube voltage is provided between the cathode and the anode, and a second effective tube voltage is provided between the electron-braking device and the anode, wherein the second effective tube voltage is lower than the first effective tube voltage.

According to an exemplary embodiment of the invention, the electron-braking device is moveable between a first position, in which it is arranged outside a pathway of an electron beam from the cathode to the target of the anode, and a second position, in which it is arranged in the pathway of the electron beam.

The second positions may comprise a plurality of sub-positions such that different grades of electron-braking effect for the electron beam hitting the target can be provided.

For example, the electron-braking device comprises a plurality of electron-brake portions intermittently arranged with non-braking portions. The electron-braking device is rotatable such that, upon rotation, the electron-brake portions are intermittently provided in the electron pathway.

For example, the anode is a rotating anode, and the electron-braking device is coupled to the anode in an isolated way.

According to an exemplary embodiment of the invention, the electron-braking device is arranged outside the direct pathway of an electron beam from the cathode to the target surface, and deflection means are provided to deflect the electron beam such that it hits the electron-braking device before hitting the target surface.

According to an exemplary embodiment of the invention, a focussing arrangement is provided to focus re-emitted electrons.

According to an exemplary embodiment of the invention, an X-ray filter is provided for the X-ray radiation generated by an un-braked high energy electron beam.

According to an exemplary embodiment of the invention, at least two electron-braking devices are provided in a row.

According to a second aspect of the present invention, an X-ray imaging system is provided, comprising a multiple X-ray tube according to one of the above-mentioned exemplary embodiments and aspects, an X-ray detector, a support for receiving an object, and a processing device. The multiple X-ray tube is provided to generate X-ray radiation with at least two different X-ray spectra. The X-ray detector is provided to receive the multiple-energy X-ray radiation after radiating the object. The processing device is provided to control the electron-braking device.

According to a third aspect of the present invention, a method for generating multiple-energy X-ray radiation is provided, comprising the following steps: a) supplying a high-voltage tube current to a cathode to emit electrons with a first energy on an electron pathway towards a target surface of an anode; and b) arranging an electron-braking device in the pathway in an intermittent manner such that at least a part of the electrons of the electron beam are slowed down such that the energy of re-emitted electrons is lower than the energy of arriving electrons. Un-braked electrons are generating a first X-ray beam with a first energy, and the re-emitted electrons are generating a second X-ray beam with a second energy, which second energy is lower than the first energy.

According to an aspect of the present invention, an X-ray tube is provided with an electron-braking device, which is also referred to as e-break, or stopping device, in order to slow electrons with, for example, energies of tens of keV down to low-energy of some eV. The electron-braking device can be selectively placed in the pathway of the electrons or out of the electron beam. It strongly reduces the energy of electrons when they pass through it. Incoming electrons loose most of their energy to electromagnetic radiation, phonons, and/or other electrons. Multiple scattered electrons may be released back into the vacuum with a rather low energy. Thus, a high-scattered electron yield can be observed. The electrons are then re-accelerated behind the electron-braking device, hit the target and generate X-rays with lower maximal energy than those generated by the primary beam. As a result, short transition times for changing the X-ray spectrum of the X-ray tube are provided. In particular, no alternation of the tube voltage is needed, thus avoiding the disadvantages connected with the large capacity of high-voltage circuitry.

These and other aspects of the invention will become apparent from and elucidated with reference to the embodiments described hereinafter.

### BRIEF DESCRIPTION OF THE DRAWINGS

Exemplary embodiments of the invention will be described in the following with reference to the following drawings.

FIG. 1 shows an example for a multiple X-ray energy tube according to the present invention.

FIG. 2 shows a CT system as an example for an X-ray imaging system according to the present invention.

FIG. 3 shows a luggage inspection device as an example for an X-ray imaging system according to the present invention.

FIG. 4 shows an example for an electron-braking device according to the present invention.

FIG. 5 shows aspects in relation with a further example of a multiple-energy X-ray tube according to the present invention.

FIGS. 6A to 6B show an example of an electron-braking device according to the present invention.

FIGS. 7A to 7B show a further example of an electron-braking device according to the present invention.

FIGS. 8A to 8B show a further example of an electron-braking device according to the present invention.

FIG. 9 shows a further example of an electron-braking device according to the present invention.

FIG. 10 shows a further example of a multiple-energy X-ray tube.

FIG. 11 shows a further example of a multiple-energy X-ray tube according to the present invention.

FIGS. 12 to 15 show further examples of multiple-energy X-ray tubes according to the present invention.

FIG. 16 shows a further aspect of an example of a multiple-energy X-ray tube according to the present invention.

FIG. 17 shows basic steps of a method for generating multiple-energy X-ray radiation according to an exemplary embodiment of the present invention.

### DETAILED DESCRIPTION OF EMBODIMENTS

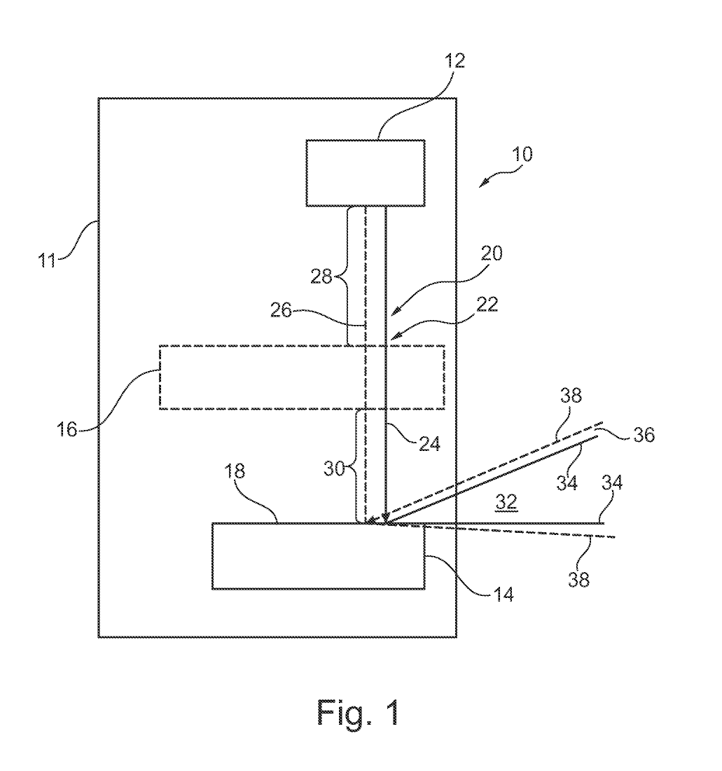

FIG. 1 shows a multiple-energy X-ray tube 10 with a cathode 12 and an anode 14. Further, an electron-braking device 16 is provided, which is shown in a dotted line, which will be explained further below. The anode 14 comprises a target surface 18 provided for generating X-rays as a result of impinging electrons. The cathode 12 is provided for emitting electrons towards the anode 14 to impinge on the target surface 18 of the anode 14. The emitting electrons are indicated with arrows 20, one of which is shown with a through-line and another one with a dotted line, which will also be explained in the following.

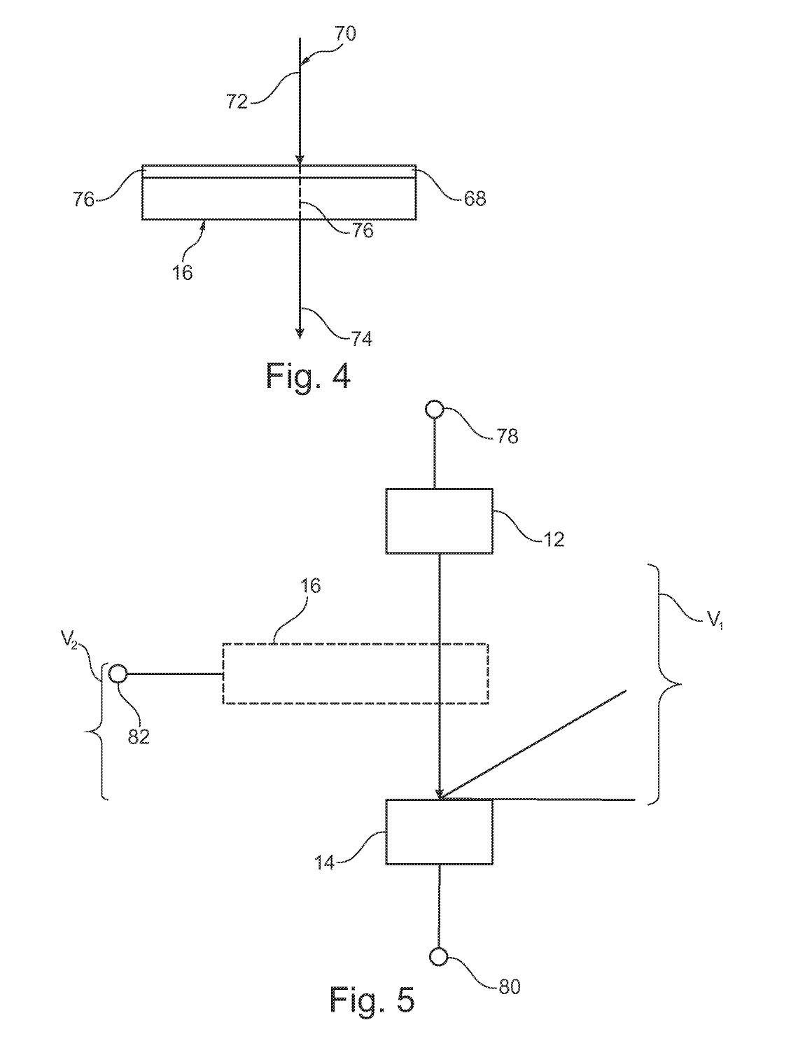

The X-ray tube 10 also comprises a vacuum housing, indicated with a reference numeral 11. It is noted that the vacuum housing is only schematically shown in FIG. 1, and is not further shown in relation with FIGS. 4 to 11.

The electron-braking device 16 is intermittently arrangeable in a pathway 22 of the electrons from the cathode 12 to the anode 14 and configured to slow at least a part of the electrons of the electrons beam such that the energy of re-emitted electrons is lower than the energy of arriving electrons.

In FIG. 1, the intermittent arrangement of the electron-braking device 16 is symbolically indicated by showing the electron-braking device 16 with the above-mentioned dotted line.

For example, the electron-braking device 16 can be arranged outside the pathway 22 of the electrons such that the electrons can be directly emitted from the cathode 12 to the anode 14, as shown with the through-line arrow 24.

The electron-braking device 16 can also be arranged in the pathway 22 such that electrons emitted from the cathode 12 towards the anode 14 first have to path the electron-braking device 16, as indicated with the dotted arrow 26. The portion of the dotted arrow 26 above the electron-braking device 16, as indicated with a first bracket 28, indicates the arriving electrons, whereas the lower portion of the dotted arrow 26, as indicated with a second bracket 30, indicates the re-emitted electrons, which re-emitted electrons have a lower energy then the arriving electrons. Of course, the terms “above” and “below” refer to the particular arrangement on the drawing sheet showing FIG. 1. These terms do not refer to the actual position in relation with the X-ray tube during use.

It is further noted that the through-line arrow 24 and the dotted line arrow 26 are shown in a side-by-side arrangement for better understanding, although they represent and relate both to the pathway 22. In other words, their side-by-side arrangement does not mean that the respective electron paths are arranged in this particular manner.

Further, a first X-ray beam 32 is indicated with two sidelines 34, and a second X-ray beam 36 is indicated with two dotted sidelines 38. Thus, it is indicated that the un-braked electrons hitting the anode 14 without being affected by the electron-braking device 16, generate a first X-ray radiation with a first energy, and the re-emitted electrons resulting from the electron-braking device 16 slowing at least a part of the electrons generate a second X-ray radiation with a second X-ray energy, wherein the second X-ray energy is lower or smaller than the first X-ray energy.

The electron-braking device 16 is also referred to as an electron-brake, e-brake or electron-stopping device, which is slowing down or stopping electrons on their way from the cathode 12 towards the anode 14, and which electron-braking device is re-emitting electrons towards the anode 14. The electron-braking device 16 reduces the energy of electrons when they pass through it. Behind the electron-braking device, the electrons are re-accelerated, wherein the re-accelerated electrons are released electrons generating X-rays with lower maximum energy than un-braked electrons from the cathode 12 which are not being affected by the electron-braking device and which thus directly hit the target.

The electrons impinging the target surface un-braked provide a high energy electron beam and the electrons re-emitted from the electron-braking device provide a low energy electron beam.

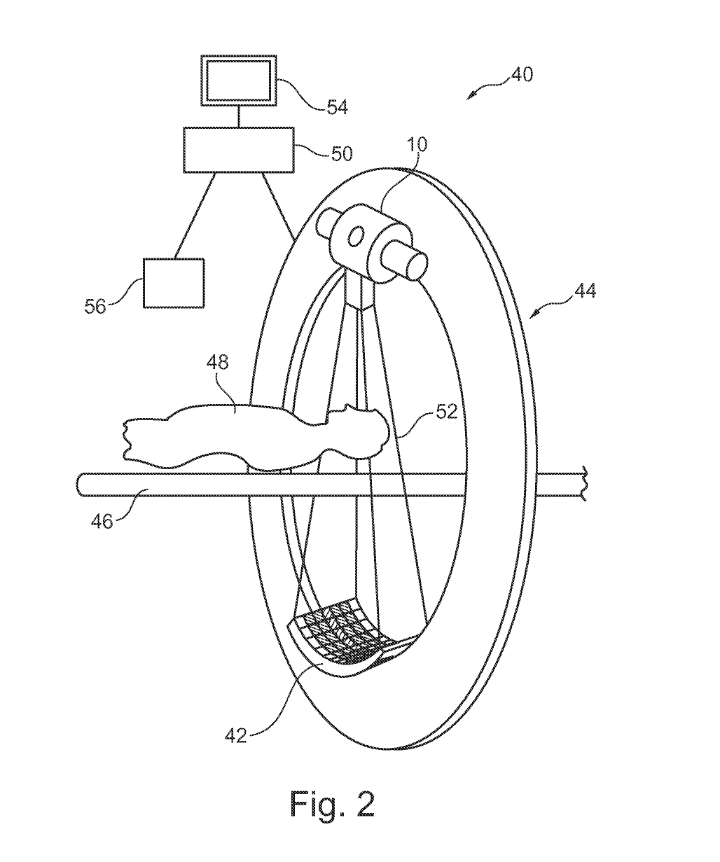

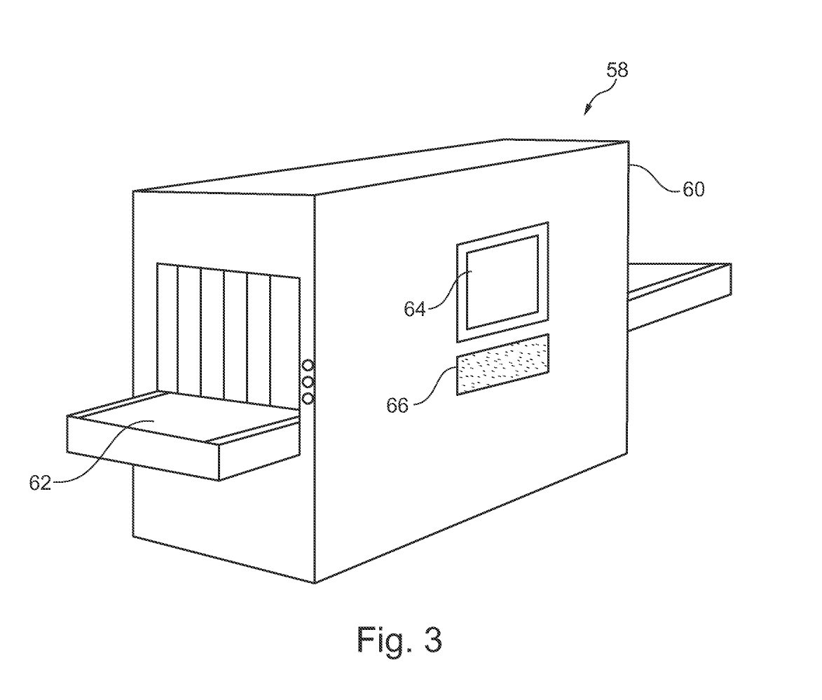

Before further explaining the multiple-energy X-ray tube according to the present invention, it is referred to FIGS. 2 and 3, showing two different examples for an X-ray imaging system.

FIG. 2 shows a CT system 40 as an example for an X-ray imaging system according to the present invention. A multiple X-ray tube 10 according to the above-mentioned example, and also according to the exemplary embodiments described further below, is provided, as well as an X-ray detector 42. The X-ray tube and the detector are provided on a gantry 44 which provides a rotational movement of the tube and the detector. Further, a support 46 for receiving an object, for example a patient 48, is provided. Further, a processing device 50 is shown. The multiple X-ray tube is provided to generate X-ray radiation with at least two different energies, which, for reasons of simplicity, are indicated with lines 52, and which X-ray radiation is provided with at least two different X-ray energies. The X-ray detector 42 is provided to receive the multiple-energy X-ray radiation 52 after radiating the object 48. The processing device 50 is provided to control the electron-braking device 16 (not further shown in detail).

Further, a display device 54 is shown, as well as an interface unit 56. The user can control the X-ray imaging system with the interface unit 56 connected to the processing device 50. The display device 54 serves as a source of information for controlling the X-ray imaging system 40, as well as for showing the image results acquired by the X-ray detector 42.

According to a further example, not shown, instead of a CT system, a C-arm system is provided, in which the multiple X-ray tube 10 and the detector 42 are provided on opposing ends of a C-arm structure. Thus, besides a rotational movement around a patient, also other trajectories for acquiring image data of an object, for example the patient, are possible.

According to the present invention, also other medical X-ray imaging systems are provided (but not shown), e.g. systems with fixedly mounted X-ray sources.

FIG. 3 shows a luggage inspection device 58 as a further example for an X-ray imaging system according to the present invention. The luggage inspection device 58 is shown with a main housing 60 through which a conveyor belt 62 passes in order to provide a support for receiving objects to be examined by the luggage inspection device, for example, suitcases and the like. Of course, instead of the conveyor belt 62, also other devices allowing a sliding movement of the luggage to be inspected can be provided. Further, a display device 64 and an interface unit 66 are shown in the outer side of the main housing 60. Of course, such display device 64 and interface unit 66, for example a keyboard, can be provided also in a separate housing arranged in the vicinity of the X-ray imaging system. Further, inside the main housing 60, a multiple X-ray tube according to the above-mentioned example, and also according to one of the exemplary embodiments described below, is provided, as well as an X-ray detector 42. Further, also not shown, a processing device is provided to control the system. The multiple X-ray tube generates X-ray radiation with at least two different X-ray energies, and the X-ray detector receives the multiple-energy X-ray radiation after radiating the objects, for example suitcases.

The luggage inspection device can be provided, for example, as a carry-on baggage or hand baggage or suitcase inspection device, known from security checkpoints at airports. However, the luggage inspection device can also be provided in form a large scale inspection device, provided to examine, for example, containers or other large scale pieces of equipment, for example to be shipped by aircraft, train, automotives or ships.

With reference back to FIG. 1, the electron-braking device 16 provides an electronic braking or slowing of the electrons passing the electron-braking device (not further shown).

According to a further example (also not shown), the electron-braking device 16 is based on electromagnetic braking of the electrons passing through the electron-braking device. According to a further example (also not shown), the electron-braking device 16 is based on electrostatic braking of the electrons passing through the electron-braking device.

According to a further example (also not shown), the electron-braking device 16 is provided with an electron-braking auxiliary target surface, which surface can be arranged in the electron pathway towards the anode such that at least a part of the electrons impinge onto the auxiliary target surface. Upon impinging, electrons are released from the electron-braking auxiliary target surface as outgoing electrons towards the anode with a lower energy than the incoming electrons. For example, the electron-braking auxiliary target surface is arranged sideward of the direct path connection. By deflecting the electron beam, the electrons hit the electron-braking auxiliary target surface in an inclined manner, which then leads to re-emitted electrons that at least partly move towards the anode target. Focussing means may be provided to support the re-emitted electrons to impinge on the anode i.e. target of the anode. Thus, electrons are impinging on the same side of the electron-braking auxiliary target surface as the released electrons used for X-ray generation.

According to a further example (also not shown), the electron-braking device 16 is an electro-magnetic electron-braking device, which provides that electrons which are passing through it, loose at least a part of their energy by generating electromagnetic radiation. For example, such electro-magnetic electron-braking device may be provided as an Undulator or Synchrotron device.

According to the example shown in FIG. 4, the electron-brake or electron-braking device 16 comprises an electron-braking layer 68 arrangeable in the electron pathway, indicated with reference numeral 70, which electron pathway is heading towards the anode (not shown in FIG. 4) such that at least a part of the electrons path through the layer. The electron-braking layer 68 is configured such that at least a part of the incoming electrons, indicated with reference numeral 72, loose at least a part of their energy to electromagnetic radiation, phonons and/or other electrons. On the rear side of the electron-braking layer, electrons, indicated with reference numeral 74, are released as outgoing electrons towards the anode with a lower energy than the incoming electrons 72. The passage through the electron-braking device 16 is indicated with a dotted line 75. This indicates both those electrons that actually pass through the layer and leave the electron-braking device at the rear side, as well as those electrons, which are so-to-speak absorbed by the electron-braking device, but which result to electrons being emitted on the rear side.

For example, the electron-braking layer 68 is a diamond layer 76. The electron-braking layer can also be made from metal, e.g. aluminium oxide, which to a certain degree turns electrically conductive, or at least electrically transmissive, when being hit by electrons. The electron-braking layer can also be made from aluminium nitride, silicon carbide, or carbon, including, for example, carbon nanotubes, and other materials with high electron yield, in particular materials with a negative electron affinity.

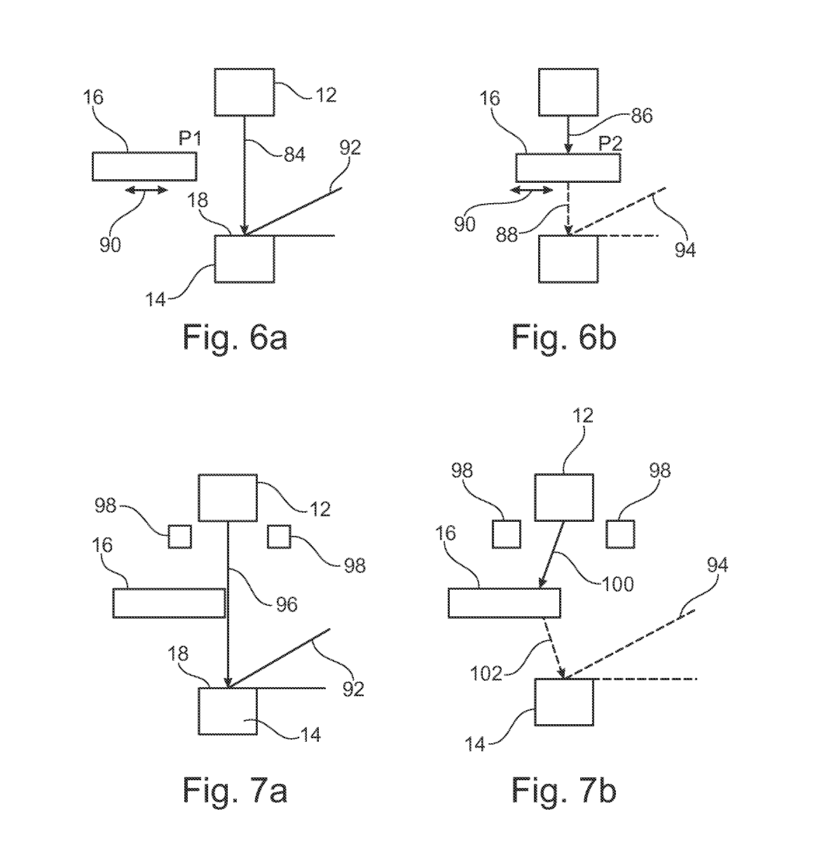

With reference to FIG. 5, according to an example, the cathode 12 is connected to a first electrical potential 78, and the anode 14 is connected to a second electrical potential 80. The electron-braking device 16, once again indicated with a dotted line, is connected to a third electrical potential 82 with a voltage arranged between the first electrical potential 78 and the second electrical potential 80. Thus, a first effective tube voltage, indicated with first voltage bracket V1, is provided between the cathode 12 and the anode 14. The second effective tube voltage, indicated with a second voltage bracket V2, is provided between the electron-braking device 16 and the anode 14. The second effective tube voltage V2 is lower than the first effective tube voltage V1.

For example, the cathode 12 is connected to ground and the anode 14 is supplied with high-voltage, wherein the electron-braking device 16 is connected to a potential between the high-voltage potential and the ground. In another example, the anode 14 is connected to ground and the cathode 12 is supplied with high-voltage, wherein the electron-braking device is connected to a potential between ground and the high-voltage potential.

For example, in a bipolar embodiment, the cathode is supplied with, for example, −60 kV and the anode is supplied with +80 kV. The electron-braking device is connected to a voltage in the range of −20 kV to +20 kV, preferably approximately 0 kV.

The electron-braking layer may be an electrically biased electron filter. For example, the electron-braking layer may be an electron filter, which is electrically connected to a filter potential. The electron-braking layer may be an electrically floating electron filter, which is isolated to the cathode potential, the anode potential, and to the ground potential. The potential of the electron-brake, or electron-braking device, may be basically self-controlled according to the yield versus potential characteristics.

According to a further aspect of the present invention, the electron-braking device can be selectively placed in the electron beam or electron pathway in order to provide the intermittent arrangement.

According to a further example, the electron-braking device 16 and the electron beam 20 are moveable in relation to each other, which will be explained for different embodiments in the following.

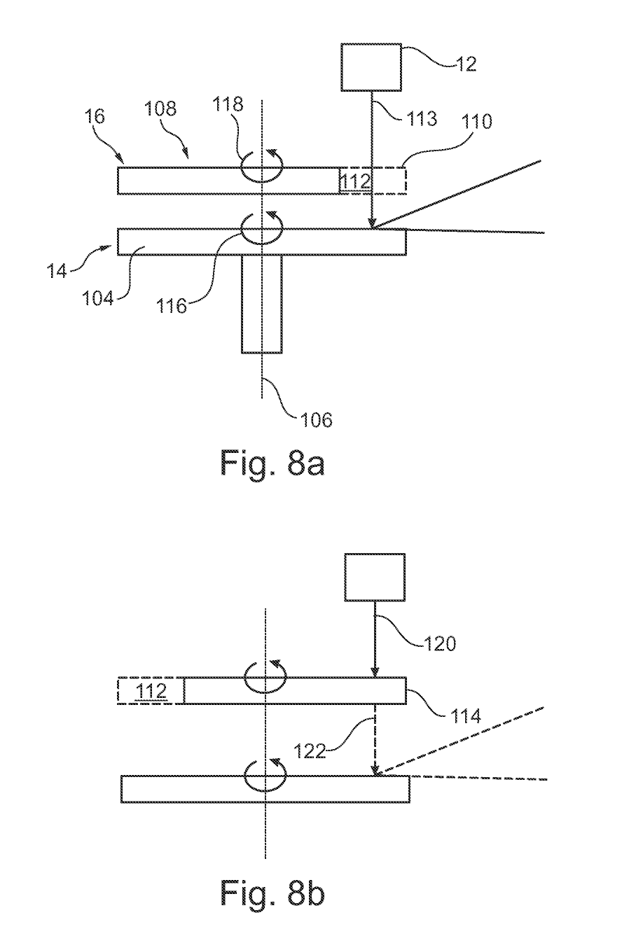

As shown in FIGS. 6A and 6B, the electron-braking device 16 is moveable between a first position P1, in which it is arranged outside a pathway 84 of an electron beam from the cathode 12 to the target 18 of the anode 14, and a second position P2, shown in FIG. 6B, in which position P2 the electron-braking device 16 is arranged in the pathway of the electron beam, which is indicated with a first arrow 86 before the braking device 16 and a second arrow 88, shown in a dotted line, following the electron-braking device 16. The moveability of the electron-braking device 16 is indicated with a double arrow 90.

Thus, the electron beam, indicated with the reference numeral 84, of FIG. 6A, leads to a generation of a first X-ray beam 92. The electrons affected by the electron-braking device 16, as indicated with dotted arrow 88, lead to a generation of a second X-ray beam 94, wherein the energy of the second X-ray beam 92 is lower than the energy of the X-ray beam 92.

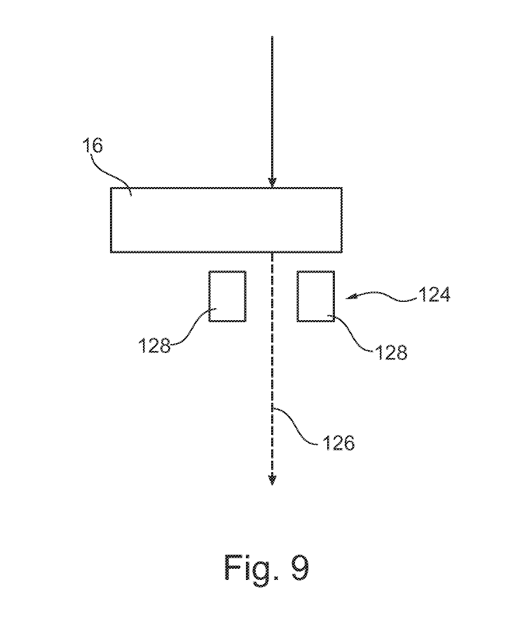

According to a further exemplary embodiment, shown in FIGS. 7A to 7B, the electron-braking device 16 is arranged outside the direct pathway of an electron beam 96 from the cathode 12 to the target surface 18 of the anode. Deflection means 98 are provided to deflect the electron beam such that at least a part of the electrons hit the electron-braking device 16 before hitting the target surface 18. Thus, as shown in FIG. 7A, the first position of the electron beam in relation to the electron-braking device is provided. When the deflection means 98 deflect the electron beam, at least a part of the electrons, as indicated with upper arrow 100, hits the electron-braking device 16, and is then re-emitted, as indicated with dotted arrow 102, on the rear side, i.e. with respect to the illustration, below the electron-braking device 16 towards the anode 14. Thus, similar to FIGS. 6A to 6B, a first X-ray beam, also indicated with reference numeral 92, and a second X-ray beam, also indicated with reference numeral 94, can be generated, wherein the energy of the second X-ray beam 94 is lower than the energy of the X-ray beam 92 of the first position.

For example, the deflection of the electron beam to hit the electron-braking device 16 is provided in an intermittent manner. The electrons from the cathode towards the target surface may be referred to as a primary electron beam, and the electron beam from the electron-braking device towards the target surface may be referred to as a secondary electron beam.

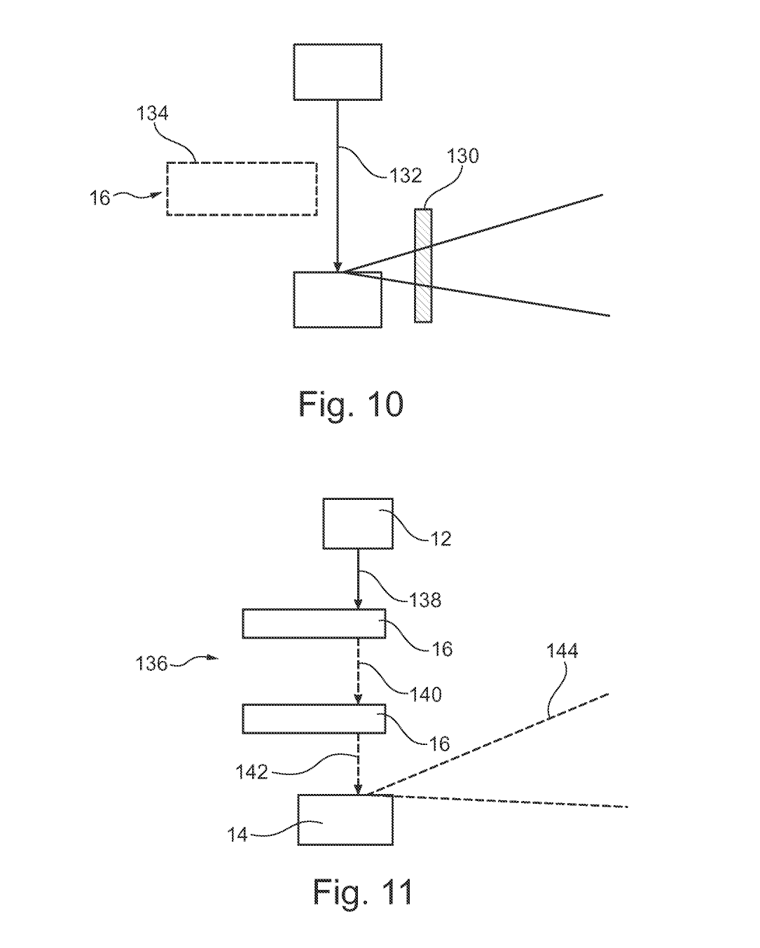

With reference to FIGS. 6A to 6B, it is noted that the movement of the electron-braking device 16 is only schematically shown. For example, such movement can be provided by an actual sliding movement of the electron-braking device. According to another example, the movement of an electron-braking device into the electron path can be provided by a rotational movement of an electron-braking device 16, which has a plurality of electron-brake portions, arranged in an intermittent manner with portions that are not acting as an electron-brake. For example, a teeth-like structure comprising a plurality of protrusions that are acting as electron-brake portions is arranged in an alternating manner with respective cut-outs in order to let the electrons pass in those cut-out sections. Thus, by a rotational movement, an electron-brake portion can be moved into the electron path, thus providing first and second positions in an alternating manner. In FIGS. 8A and 8B, a further example is shown, wherein the anode 14 is a rotating anode 104, rotatable around a rotating axis 106. The electron-braking device 16 is provided as a rotating disc 108, comprising a plurality of protrusions, indicated with dotted lines 110 in FIG. 8A, arranged in an alternating manner with cut-outs, as also indicated in FIG. 8A with reference numeral 112. The protrusions 110 act as electron-brake portions 114, as indicated in FIG. 8B. The cut-outs 112 do not affect the electron beam, as indicated with an arrow 113 leading from the cathode 12 towards the anode 14 in a direct manner, thus generating a first X-ray beam. The rotation of the anode 104 is indicated with a circular arrow symbol 116, and the rotational movement of the electron-braking device 16 is indicated with a second rotating arrow symbol 118.

The examples shown in FIGS. 8A to 8B show the electron-braking device 16 to be rotatable around the rotating axis 106 of the rotating anode 104. However, according to the present invention, the electron-braking device 16 can also be rotated around a rotating axis which is not arranged in a concentric manner as shown in FIGS. 8A to 8B.

It is further noted that FIGS. 8A to 8B show a cut-out, or protrusion, for only the left and right portions of the electron-braking device 16. However, a plurality of such protrusions and cut-outs is provided in a circumferential manner around a disc-like rotating electron-braking device.

FIG. 8B shows the situation where the protrusion 114 is arranged in the pathway of the electrons, thus braking or at least slowing down arriving electrons, indicated with first arrow 120, and resulting in re-emitted electrons 122, which then generate a second X-ray beam.

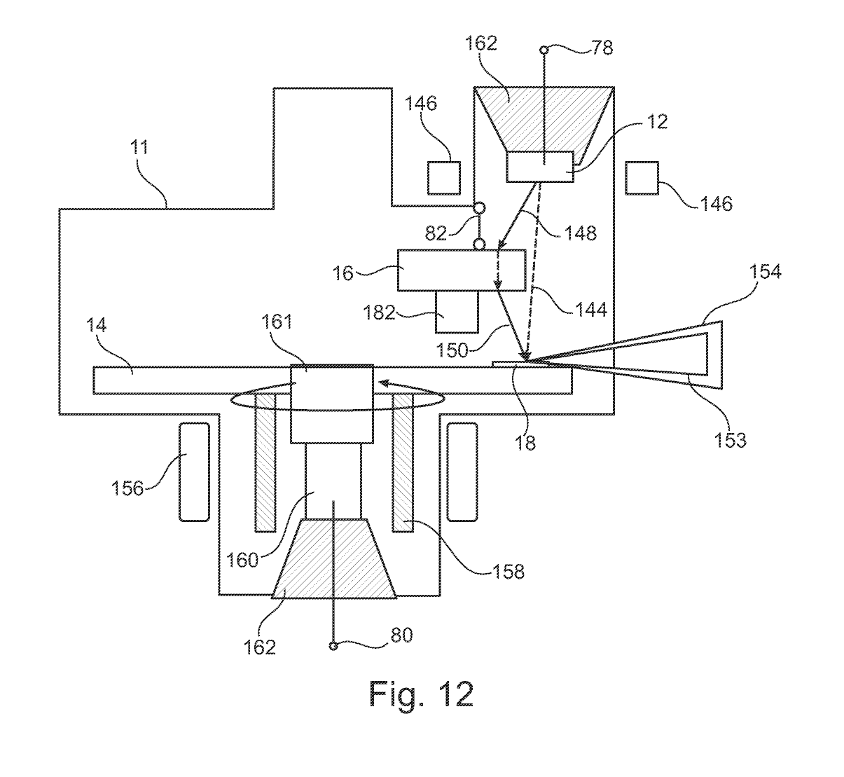

A further aspect is shown in FIG. 9, where a focussing arrangement 124 is provided to focus re-emitted electrons, which re-emitted electrons are indicated with a dashed line arrow 126.

For example, a pair of electromagnetic means 128 is provided below the electron-braking device 16. Instead of a pair of electromagnetic means, also three, four or more electromagnetic means, or also a circular arrangement acting as an electromagnetic means, can be provided.

According to a further example (not shown), the focussing arrangement 124 comprises electrostatic means, also as a pair, three, four, or more or other structured electrostatic means.

According to a further example, in case the electron-braking device 16 comprises a plurality of brake portions, as mentioned in relation with FIGS. 8A to 8B, the secondary focussing element is provided for each brake portion.

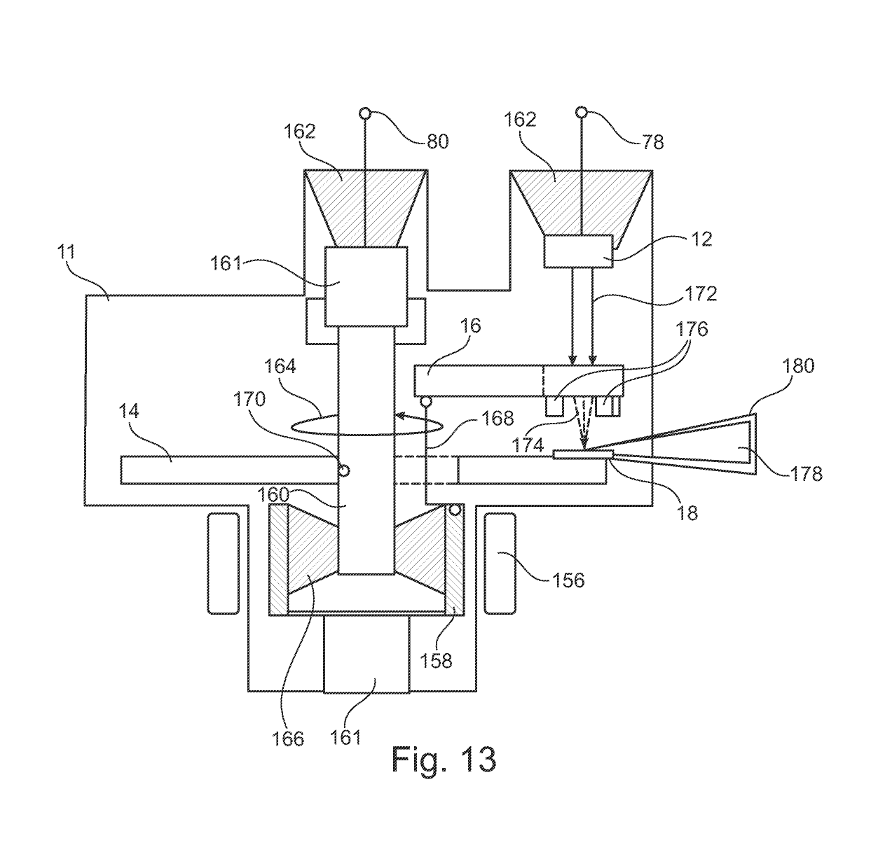

As shown in FIG. 10, according to a further exemplary embodiment, an X-ray filter 130 is provided for the X-ray radiation generated by an un-braked high energy electron beam, indicated with reference numeral 132. A dotted line structure 134 indicates that the electron-braking device 16 does not provide any electron-braking effect when the X-ray filter 130 is arranged in the pathway of the X-ray beam. For example, the X-ray filter 130 is arranged inside the tube housing. The filter can filter the high-energy X-ray beam to filter out radiation with lower energy for achieving a better separation of X-ray spectra. The X-ray radiation generated by the lower energy electron, slowed down by the electron-braking device, is then not filtered or filtered to a lesser degree.

According to a further example, the X-ray filter 130 is provided attached to the X-ray window of the tube, for example on the inside, or even on the outside.

According to a further example, the X-ray filter 130 is provided in the close vicinity of the outside of the X-ray tube's housing.

For example, the filter is synchronized with the activation of the electron-braking device.

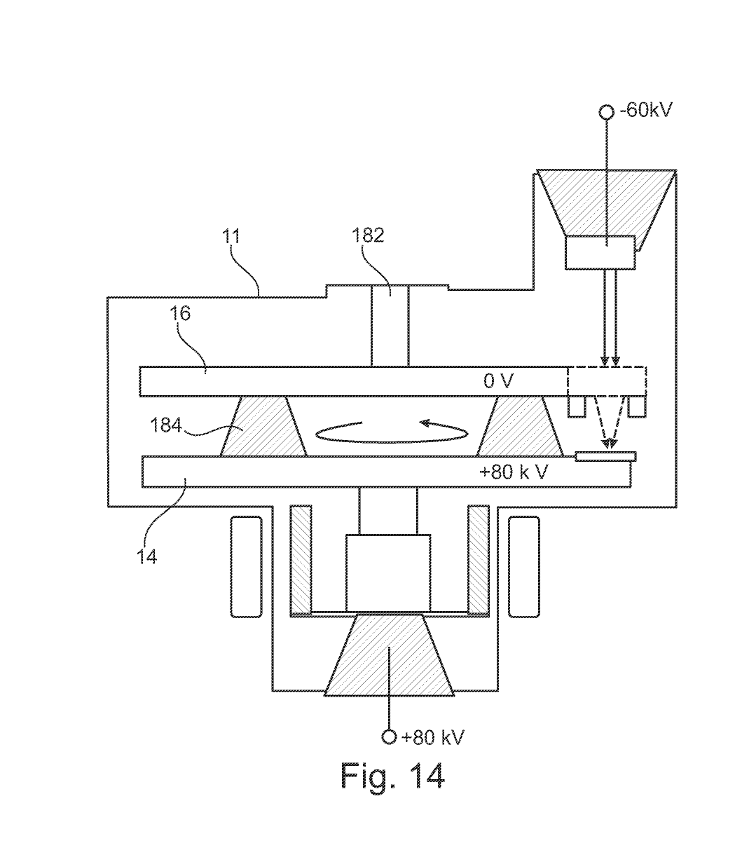

According to a further exemplary embodiment, shown in FIG. 11, at least two electron-braking devices 16 are provided in a row 136. The electron-braking devices arranged in the row 136 are intermittently arrangeable in a pathway of the electrons from the cathode 12 to the anode 14. The situation where the electron-braking device 16 acts on the electrons in the pathway is shown in FIG. 11. A first arrow 138 indicates electrons coming from the cathode 12 with so-to-speak full energy. By passing the first electron-braking device 16 of the at least two electron-braking devices, the energy of the electrons is reduced, indicated with a dashed line arrow 140, leading from the first electron-braking device 16 to the next electron-braking device 16. The latter then further reduces the energy of the electron beam, resulting in a further electron beam portion, indicated with dotted arrow 142. Thus, the electron beam is generating an X-ray beam with reduced X-ray energy. Thus, by providing electron-braking devices in a row, each electron-braking device has to carry a reduced braking load only, since the braking of electrons is divided into sub-portions. For example, this provides advantages in particular with respect to energy (heat) dissipation.

According to a further aspect of the present invention, the cathode 12 may be supplied with at least two different tube voltages in synchronization with the activation of the electron-braking device 16. For example, in order to provide at least two different X-ray energies with a sufficient delta in their X-ray spectra, it is possible to provide two different tube voltages, which, when taken alone, are not sufficient to provide the desired or required separation of the X-ray spectra of the X-ray beams, and combine these two voltages with an electron-braking device according to the present invention, which has a braking effect that, when taken alone, would also not be sufficient to provide the respective separation of the X-ray spectra. Due to the combination, a respective separation can be achieved.

Of course, also further separation, that is a larger separation, can be provided by combining the electron-braking device with different tube voltages.

It is further noted that also different portions with different electron-braking characteristic can be provided in order to achieve more than two different X-ray beams with different X-ray energies.

Of course, multiple e-brakes of different kind may be combined.

According to a still further example, at least two electron-braking characteristics are provided, for example by arranging first portions with a first braking characteristic and second portions with a second characteristic followed by a non-electron-braking portion in a consecutive repeating order.

In combination with two or more different tube voltages, it is possible to provide a plurality of different X-ray energies.

According to a further example (not shown), a heat dissipation arrangement is provided for the electron-braking device. For example, the electron-braking device is rotating for better heat dissipation.

According to a further example, finned- or channel-like metal cooling body structures are provided for thermal management of the electron-braking device, which so-to-speak transforms at least a part of the electron energy into heat energy. Partially coated sections may be provided with a scattered electron releasing layer. For example, a finned Copper (Cu) structure is coated with a diamond layer. Further, a cooling arrangement may be provided for the electron-braking device, e.g. liquid metal cooling.

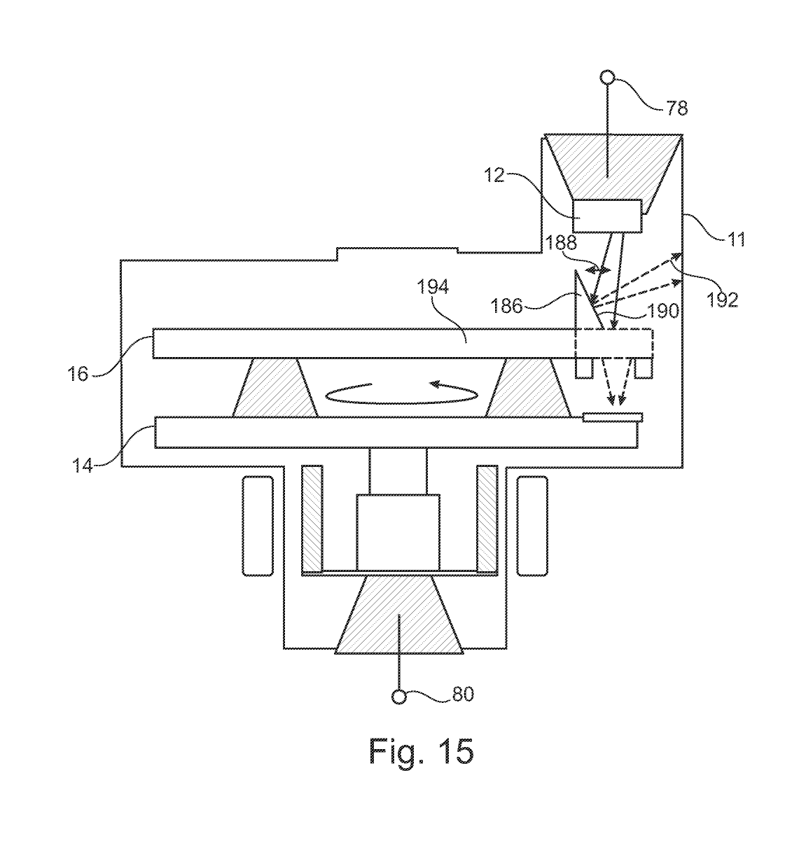

FIG. 12 shows a further exemplary embodiment, wherein the electron-braking device 16 is arranged outside the direct pathway between the cathode 12 and the target surface 18 of the anode 14, which is provided as a rotating anode. The target surface 18 is also referred to as a focal spot. An un-deflected electron beam 144 indicates electrons impinging on the focal spot with a first energy to generate a first X-ray beam 153. By activating deflection devices 146, a deflected beam 148 is provided which hits the electron-braking device 16, which then provides a beam 150 of re-emitted electrons. A focussing element 152 provides are re-focussing of the re-emitted electrons such that they impinge on the focal spot. As a result, the re-emitted electrons 150 generate a second X-ray beam 154.

For example, the cathode is supplied with a first voltage 78 of −60 kV, and the anode is supplied with a voltage 80 of +80 kV. The electron-braking device 16 is provided with a third voltage 82 of 0 V, as indicated with a connecting line to the housing 11. In order to provide a rotating movement of the anode 14, a stator 156 is provided outside the housing, and a rotor 158, as part of a motor drive, is provided inside the housing, and coupled to the anode 14. The rotor 158 is isolated from the anode disc. The voltage supply of the anode is provided with a stationary axis 160, which is also on +80 kV. Further, high-voltage insulators 162 are provided for the anode connection and the cathode connection. Further, an anode bearing 161 is provided.

For example, the first X-ray beam has 140 keV max, and the second X-ray beam 154 has 80 keV max.

The tube housing is also referred to as tube frame, which is on 0 V.

The example shown in FIG. 13 indicates an electron-braking device 16 being coupled to the rotating anode 14. The coupled rotating movement is indicated with circular arrow symbol 164. It is further noted that for similar paths, similar reference numbers are used.

In the example shown in FIG. 13, the rotating axis is supplied with the second voltage 80 from above, wherein a rotating insulator 166 is provided at the lower edge of the rotating axis 160. In order to supply the third voltage, for example 0 V, to the electron-braking device 16, a connection 168 is provided between the rotor 158, which is connected to the tube frame, or housing 11, by the lower high-voltage insulation, connecting the ground potential with the electron-braking device 16. The anode 14 is electrically connected to the voltage supply 80 in form a symbolically shown connection 170 to the rotating axis.

As already discussed in relation with FIGS. 8A and 8B, by rotating an electron-braking device together with the anode, it is possible to provide an electron-braking portion in the pathway between the cathode, also referred to as electron emitter, and the focal spot or target surface 18.

Two arrows 172 indicate a primary electron beam, which is hitting the electron-braking device 16 in the position shown in FIG. 13. As a result re-emitted electrons 174 leave the electron-braking device 16 heading towards the focal spot. A pair of focussing elements 176 provides a focussing of the re-emitted electrons 174. Similar as shown in FIG. 12, a first X-ray beam 178 and a second X-ray beam 180 can be generated.

The example in FIG. 14 shows a further embodiment of an electron-braking device 16 coupled to the rotating anode 14. The electron-braking device 16 may have an auxiliary current contact 182 to ambient, for example, through a ball bearing to the housing or vacuum envelope 11. Insulators 184 provide a coupling between the electron-braking device 16 and the anode 14, which still allows two different potentials supplied to the electron-braking device 16 and the anode 14. The main anode bearing, for example the one below the anode disc, may be a heat-conducting spiral groove bearing. The ball bearing 182 may also provide a better heat dissipation of the heat generated by braking the electrons and reducing their energy.

FIG. 15 shows a further aspect in relation with a rotating anode and an electron-braking device being coupled to each other. However, it is noted that although shown in a coupled manner, the coupling is not an essential part relating to the following aspects. Deflection means 186, which are also referred to as steering means, are provided to steer at least a part of the electron beam from zones of high secondary electron yield (raising the potential to the positive) into zones with low electron yield (pulling the potential to the negative). The steering is indicated with a small double arrow 188. For example, the steering means are provided to deflect the electron beam to hit a reflecting surface 190 such that only a part of the electron beam hits the electron-braking device 16. This is indicated with the first of the two arrows hitting the reflective surface 190, leading to reflected electron beams 192, whereas the other one of the two primary electron beams hits the electron-braking device 16.

For example, the first voltage 78, for example −60 kV, is supplied to the cathode 12 and the anode is supplied with the second voltage 80, for example +80 kV.

The electron-braking device 16 is shown to be electrically floating, for example having a potential 194 of 0 V.

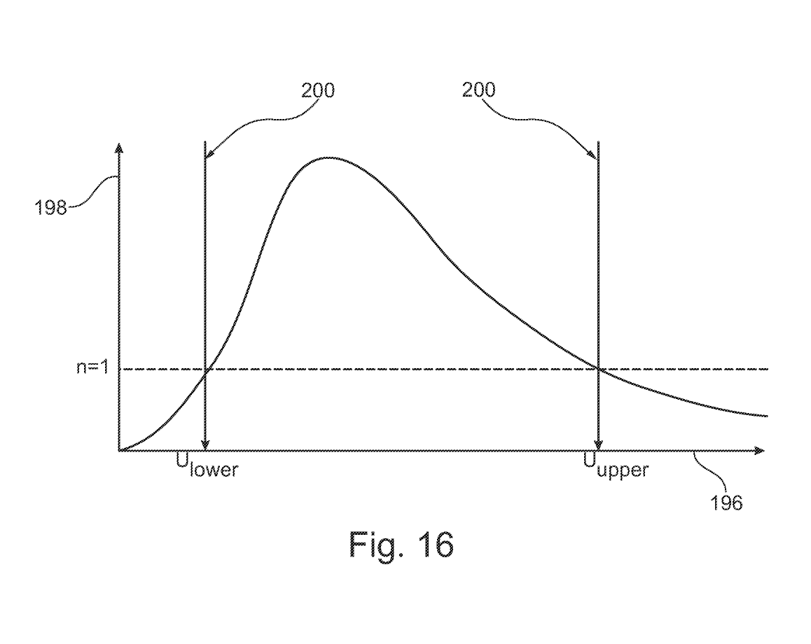

The electric floating of the electron-braking device is possible since the net current to the electron-braking device can be made comparatively small (incoming minus outgoing electrons). Its potential may be basically self-controlled according to the yield versus voltage characteristics as shown in FIG. 16. A horizontal line 196 indicates energy of incoming electrons and a vertical line 198 indicates scattered electron yield. Two arrows 200 indicate so-called stable sweet spots.

Also with reference to FIG. 15, it is noted that initial (switch-on) charging or minor corrections (aging, tolerances) may be supported by temporarily steering part of the primary beam as described above.

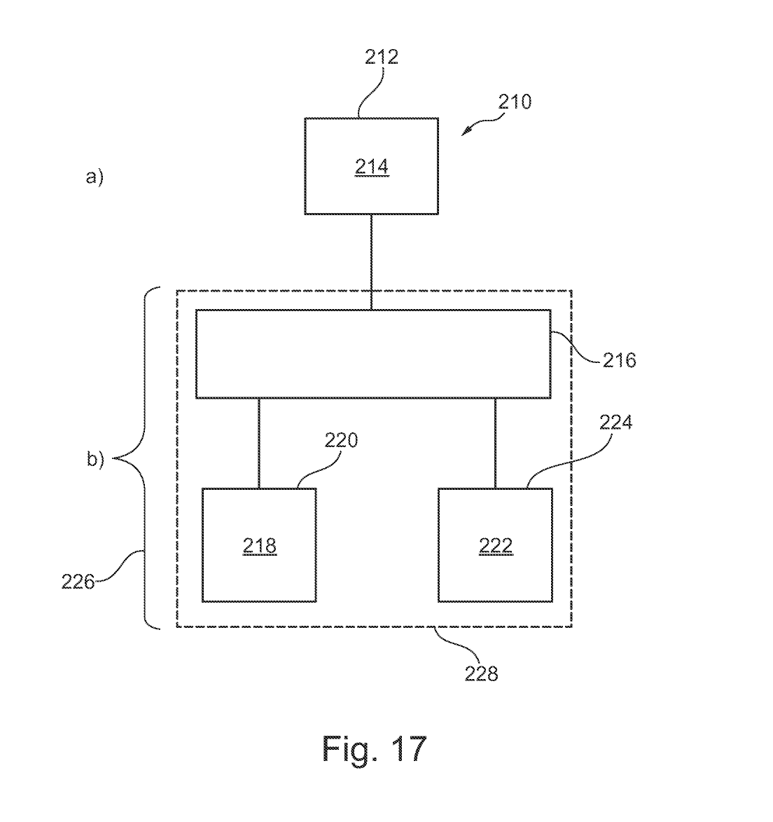

FIG. 17 shows basic method steps of a method 210 for generating multiple energy X-ray radiation, comprising the following steps: In a supply step 212, a high-voltage tube current 214 is supplied to a cathode to emit electrons with a first energy on an electron pathway towards a target surface of an anode. In an arrangement step 216, an electron-braking device is arranged in the pathway in an intermittent manner such that at least a part of the electrons of the electron beam are slowed down such that the energy of re-emitted electrons is lower than the energy of arriving electrons. Thus, un-braked electrons are generating a first X-ray beam 218 with a first energy in a first generation sub-step 220, and the re-emitted electrons are generating a second X-ray beam 222 with a second energy, which second energy is lower than the first energy, in a second generation sub-step 224. The supply step 212 is also referred to as step a), the arrangement step 216 as step b), comprising the generation sub-steps, as indicated with bracket 226. Further, it is noted that the generation sub-steps 220, 224 are arranged simultaneously to the arrangement step 216, which is indicated by an enclosing frame 228 shown in a dotted line.

In another exemplary embodiment of the present invention, a computer program or a computer program element is provided that is characterized by being adapted to execute the method steps of the method according to one of the preceding embodiments, on an appropriate system.

The computer program element might therefore be stored on a computer unit, which might also be part of an embodiment of the present invention. This computing unit may be adapted to perform or induce a performing of the steps of the method described above. Moreover, it may be adapted to operate the components of the above described apparatus. The computing unit can be adapted to operate automatically and/or to execute the orders of a user. A computer program may be loaded into a working memory of a data processor. The data processor may thus be equipped to carry out the method of the invention.

This exemplary embodiment of the invention covers both, a computer program that right from the beginning uses the invention and a computer program that by means of an up-date turns an existing program into a program that uses the invention.

Further on, the computer program element might be able to provide all necessary steps to fulfil the procedure of an exemplary embodiment of the method as described above.

According to a further exemplary embodiment of the present invention, a computer readable medium, such as a CD-ROM, is presented wherein the computer readable medium has a computer program element stored on it which computer program element is described by the preceding section.

A computer program may be stored and/or distributed on a suitable medium, such as an optical storage medium or a solid state medium supplied together with or as part of other hardware, but may also be distributed in other forms, such as via the internet or other wired or wireless telecommunication systems.

However, the computer program may also be presented over a network like the World Wide Web and can be downloaded into the working memory of a data processor from such a network. According to a further exemplary embodiment of the present invention, a medium for making a computer program element available for downloading is provided, which computer program element is arranged to perform a method according to one of the previously described embodiments of the invention.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

1. A multiple-energy X-ray tube (10), comprising:
a cathode (12);
an anode (14); and
an electron-braking device (16);
wherein the anode comprises a target surface (18) provided for generating X-rays as a result of impinging electrons;
wherein the cathode is provided for emitting electrons (20) towards the anode to impinge on the target surface of the anode;
wherein the electron-braking device is intermittently arrangeable in a pathway (22) of the electrons from the cathode to the anode and configured to slow at least a part of the electrons of the electron beam such that the energy of re-emitted electrons is lower than the energy of arriving electrons.

2. Multiple-energy X-ray tube according to claim 1, wherein the electron-braking device comprises an electron-braking layer (68) arrangeable in the electron pathway towards the anode such that at least a part of the electrons pass through the layer;
wherein the electron-braking layer is configured such that at least a part of the incoming electrons loose at least a part of their energy to electromagnetic radiation, phonons and/or other electrons; and
wherein on the rear side of the electron-braking layer, electrons are released as outgoing electrons (74) towards the anode with a lower energy than the incoming electrons (72).

3. Multiple-energy X-ray tube according to claim 1, wherein the electron-braking device comprises an electron-braking auxiliary target surface, arrangeable in the electron pathway towards the anode such that at least a part of the electrons impinge onto the auxiliary target surface;
wherein from the electron-braking auxiliary target surface, electrons are released as outgoing electrons towards the anode with a lower energy than the incoming electrons.

4. Multiple-energy X-ray tube according to claim 1, comprising an electro-magnetic electron-braking device;
wherein electrons passing through it, loose energy by generating electromagnetic radiation.

5. Multiple-energy X-ray tube according to claim 1, wherein the cathode is connected to a first electrical potential (78);
wherein the anode is connected to a second electrical potential (80);
wherein the electron-braking device is connected to a third electrical potential (82) with a voltage arranged between the first and the second electrical potential; and
wherein a first effective tube voltage is provided between the cathode and the anode, and a second effective tube voltage is provided between the electron-braking device and the anode, wherein the second effective tube voltage is lower than the first effective tube voltage.

6. Multiple-energy X-ray tube according to claim 1, wherein the electron-braking device and the electron beam are moveable in relation to each other.

7. Multiple-energy X-ray tube according to claim 6, wherein the electron-braking device is movable between a first position (P1), in which it is arranged outside a pathway (84) of an electron beam from the cathode to the target of the anode, and a second position (P2), in which it is arranged in the pathway of the electron beam.

8. Multiple-energy X-ray tube according to claim 6, wherein the anode is a rotating anode (108) and wherein the electron-braking device is coupled to the anode in an isolated way; wherein the electron-braking device comprises a plurality of electron-brake portions (114); and wherein upon rotation of the anode, the electron-brake portions are intermittently provided in the electron pathway.

9. Multiple-energy X-ray tube according to claim 1, wherein the electron-braking device is arranged outside the direct pathway of an electron beam from the cathode to the target surface, and wherein deflection means (98) are provided to deflect the electron beam such that it hits the electron-braking device before hitting the target surface.

10. Multiple-energy X-ray tube according to claim 1, wherein a heat dissipation arrangement is provided for the electron-braking device.

11. Multiple-energy X-ray tube according to claim 1, wherein at least two electron-braking devices are provided in a row (136).

12. An X-ray imaging system (40; 58), comprising:
a multiple X-ray tube (10) according to claim 1;
an X-ray detector (42);
a support (46) for receiving an object: and
a processing device (50);
wherein the multiple X-ray tube is provided to generate X-ray radiation with at least two different X-ray energies;
wherein the X-ray detector is provided to receive the multiple-energy X-ray radiation after radiating the object; and
wherein the processing device is provided to control the electron-braking device.

13. (canceled)

14. (canceled)

15. (canceled)
